(19) United States
(12) Patent Application Publication
(10) Pub. No.: US 2020/0099272 A1
(43) Pub. Date: Mar. 26, 2020

(54) DAMPER MECHANISM AND ACTUATOR

(71) Applicant: NIDEC SANKYO CORPORATION, Nagano (JP)

(72) Inventors: Tadashi TAGUCHI, Nagano (JP); Takashi YUDA, Nagano (JP); Yasushi HASEGAWA, Nagano (JP)

(21) Appl. No.: 16/576,840

(22) Filed: Sep. 20, 2019

(30) Foreign Application Priority Data
Sep. 20, 2018 (JP) 2018-175497

(51) Int. Cl. H02K 5/24; H02K 33/02; F16F 15/08

(52) U.S. Cl. CPC H02K 5/24; F16F 15/08; H02K 33/02

(57) ABSTRACT

A damper mechanism may include a fixed body; a movable body; and a damper member disposed between the fixed body and the movable body so as to be in contact with both of the movable body and the fixed body. The damper member may include a gel member, and a first sheet member joined to a surface of the gel member on a side of one of the movable body and the fixed body.

### CROSS REFERENCE TO RELATED APPLICATION

The present application claims priority under 35 U.S.C. § 119 to Japanese Patent Application No. 2018-175497 filed Sep. 20, 2018, the entire content of which is incorporated herein by reference.

### FIELD OF THE INVENTION

At least an embodiment of the present invention relates to a damper mechanism including a gel member, and an actuator.

### BACKGROUND

As an apparatus for generating vibration by a magnetic drive mechanism, there has been proposed an actuator having a fixed body for holding a cylindrical coil and a movable body supported by the fixed body via a damper member. The movable body is provided with a permanent magnet. The actuator is provided with a gel member such as a silicone gel between the movable body and the fixed body, and a damper mechanism is constituted by the gel member (Refer to Japanese Unexamined Patent Application Publication No. 2017-60207).

However, the gel member such as the silicone gel is easily bent due to the weight of gel member itself or the like. Moreover, since the gel member itself has adsorptivity, much effort is required for handling the damper member. For example, after the suction head holds the gel member from the back side and the gel member is placed on the movable body or the fixed body, if the suction head is separated from the gel member, the gel member is sucked by the suction head. As a result, the gel member is separated from the movable body or the fixed body.

### SUMMARY

In view of the above problems, at least an embodiment of the present invention provides a damper mechanism and an actuator with which handling of a damper member using a gel member is facilitated.

In order to solve the above problems, one aspect of the damper mechanism according to at least an embodiment of the present invention includes a fixed body, a movable body, a damper member disposed between the fixed body and the movable body so as to be in contact with both of the movable body and the fixed body, wherein the damper member includes a gel member, and a first sheet member joined to a surface of the gel member on a side of one of the movable body and the fixed body.

In at least an embodiment of the present invention, the damper member includes a gel member, and the first sheet member is joined to the surface of the gel member on one side. For this reason, when assembling the damper mechanism, the damper member is less likely to be bent excessively by its own weight etc. Further, when the suction head or the like holds the damper member, the damper member can be held from the side of the first sheet member. Therefore, the suction head or the like does not contact the gel member. Therefore, the situation where the damper member is adsorbed to the suction head or the like is less likely to occur. Therefore, it is easy to handle the damper member using the gel member.

At least an embodiment of the present invention can adopt an aspect in which the first sheet member is bonded to the side of one of the movable body and the fixed body. According to this aspect, even when the damper member is bonded, the first sheet member can be bonded. For this reason, even when the gel member has a property of being difficult to bond, the damper member can be easily bonded.

At least an embodiment of the present invention can adopt an aspect in which the damper member includes a second sheet member joined to a surface of the gel member on a side of the other of the movable body and the fixed body. According to this aspect, when the suction head or the like holds the damper member, even when the damper member is held from any side of the first sheet member side and the second sheet member side, the suction head or the like does not contact the gel member. Therefore, the situation where the damper member is adsorbed to the suction head or the like is less likely to occur. Therefore, it is easy to handle the damper member using the gel member.

At least an embodiment of the present invention can adopt an aspect in which the second sheet member is bonded to the side of the other of the movable body and the fixed body. According to this aspect, even when bonding the damper member, the second sheet member can be bonded. For this reason, even when the gel member has a property of being difficult to bond, the damper member can be easily bonded.

At least an embodiment of the present invention can adopt an aspect in which the gel member is in a state of being compressed between the movable body and the fixed body.

At least an embodiment of the present invention can adopt an aspect in which the gel member includes a silicone gel.

At least an embodiment of the present invention can adopt an aspect in which the damper member has a plate shape.

At least an embodiment of the present invention can adopt an aspect in which the damper member has a cylindrical shape.

An actuator can be provided using the damper mechanism to which at least an embodiment of the present invention is applied. In this case, the actuator includes a magnetic drive mechanism configured to move the movable body relative to the fixed body.

Another aspect of at least an embodiment of the present invention is a damper mechanism including a damper member disposed so as to be in contact with a movable body, and the damper member includes a gel member, and a sheet member joined to a surface of the gel member on a side of the movable body.

In the other aspect of at least an embodiment of the present invention, the damper member includes a gel member, and the sheet member is joined to the surface of the gel member on the movable body side. For this reason, when assembling the damper mechanism, the damper member is less likely to be bent excessively by its own weight etc. Further, when the suction head or the like holds the damper member, the damper member can be held from the side of the sheet member, and the suction head or the like does not contact the gel member. Therefore, the situation where the damper member is adsorbed to the suction head or the like is less likely to occur. Accordingly, it is easy to handle the damper member using the gel member.

In this case, an aspect in which the sheet member is bonded to the movable body may be adopted. According to this aspect, even when the damper member is bonded, the sheet member can be bonded. For this reason, even when the gel member has a property of being difficult to bond, the damper member can be easily bonded.

In the damper mechanism and the actuator according to at least an embodiment of the present invention, the damper member includes the gel member. The sheet member is joined to the gel member. For this reason, when assembling the damper mechanism, the damper member is less likely to be bent excessively by its own weight etc. In addition, when the suction head or the like holds the damper member, it is possible to hold the damper member from the side of the seat member. Also, the suction head or the like does not contact with the gel member. Therefore, the situation where the damper member is adsorbed to the suction head or the like is less likely to occur. Accordingly, it is easy to handle the damper member using the gel member.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view illustrating one aspect of an actuator according to a first embodiment of the present invention;

FIG. 2 is a YZ sectional view of the actuator in FIG. 1;

FIG. 3 is an exploded perspective view of the actuator in FIG. 1;

FIG. 4 is an exploded perspective view of the actuator in FIG. 1 disassembled into a fixed body and a movable body;

FIG. 5 is an exploded perspective view of the fixed body in FIG. 4 as viewed from the other side in a first direction;

FIG. 6 is a perspective view of a damper member in FIG. 2 and the like;

FIG. 7 is an explanatory diagram of an apparatus for manufacturing the damper member in FIG. 6;

FIG. 8 is an explanatory view illustrating a method for manufacturing the damper member in FIG. 6;

FIG. 9 is a perspective view illustrating one aspect of an actuator according to a second embodiment of the present invention;

FIG. 10 is an exploded perspective view schematically illustrating a cross section of the actuator in FIG. 9;

FIG. 11 is an exploded perspective view of the actuator in FIG. 9;

FIG. 12 is an exploded perspective view of an actuator according to a third embodiment of the present invention; and

FIG. 13 is an explanatory view illustrating a method for manufacturing a damper member in FIG. 12.

### DETAILED DESCRIPTION

At least an embodiment of the present invention will be described with reference to the drawings. In the following description, the case where one side member holding a coil is a support member and the other side member holding a permanent magnet is a movable body will be mainly described.

### First Embodiment

In the description of the present embodiment, X is given in the linear motion direction (vibration direction) of the movable body 6, Z is given in a first direction crossing the second direction X, and Y is given in a third direction crossing the first direction Z and the second direction X. In addition, X1 is given to one side in the second direction X, X2 is given to the other side in the second direction X, Z1 is given to one side in the first direction Z, Z2 is given to the other side in the first direction Z, Y1 is given to one side of the third direction Y, and Y2 is given to the other side of the third direction Y.

### General Configuration

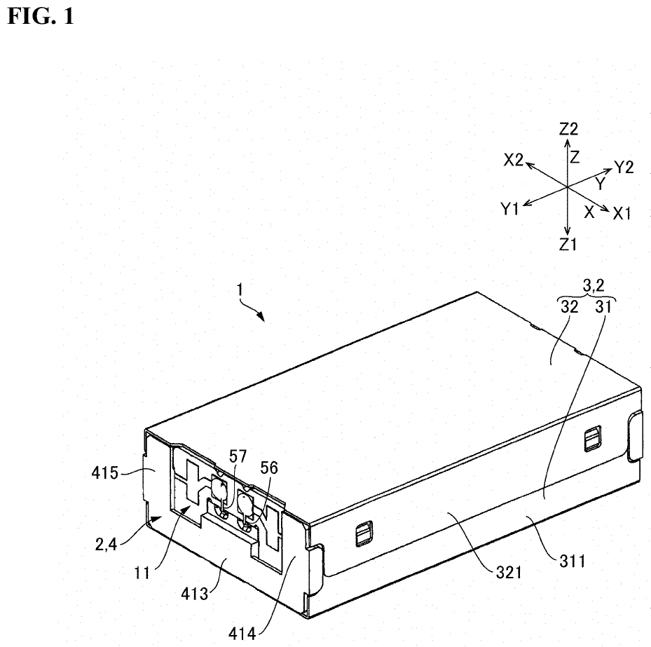

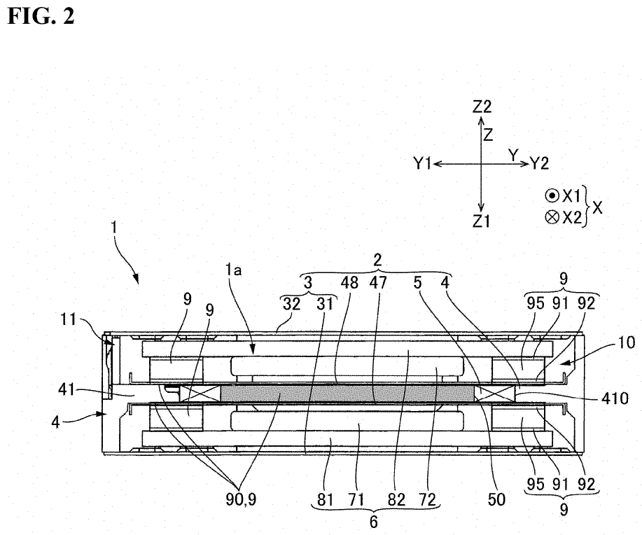

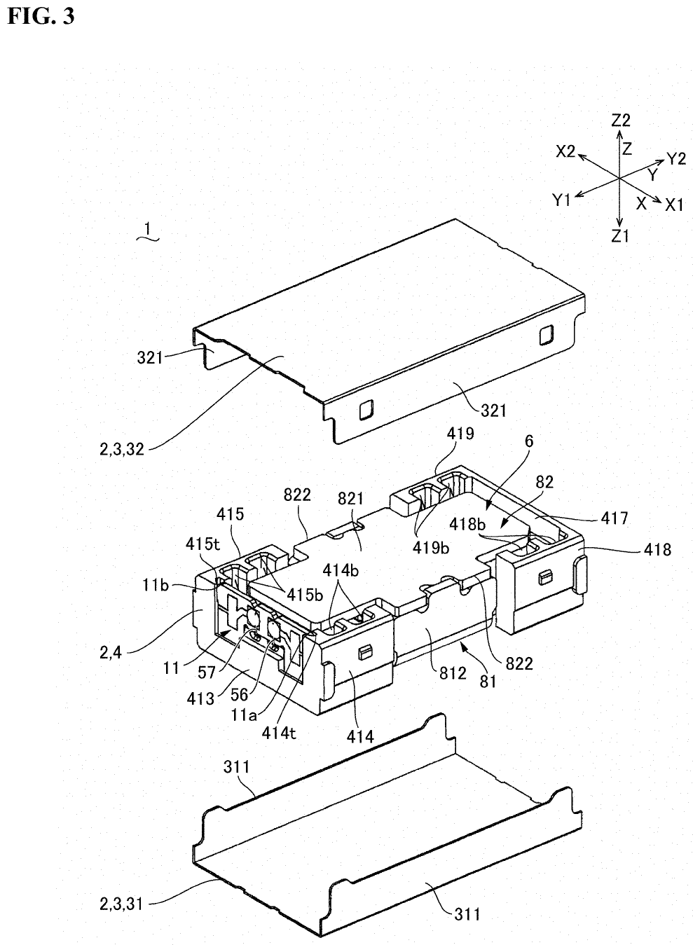

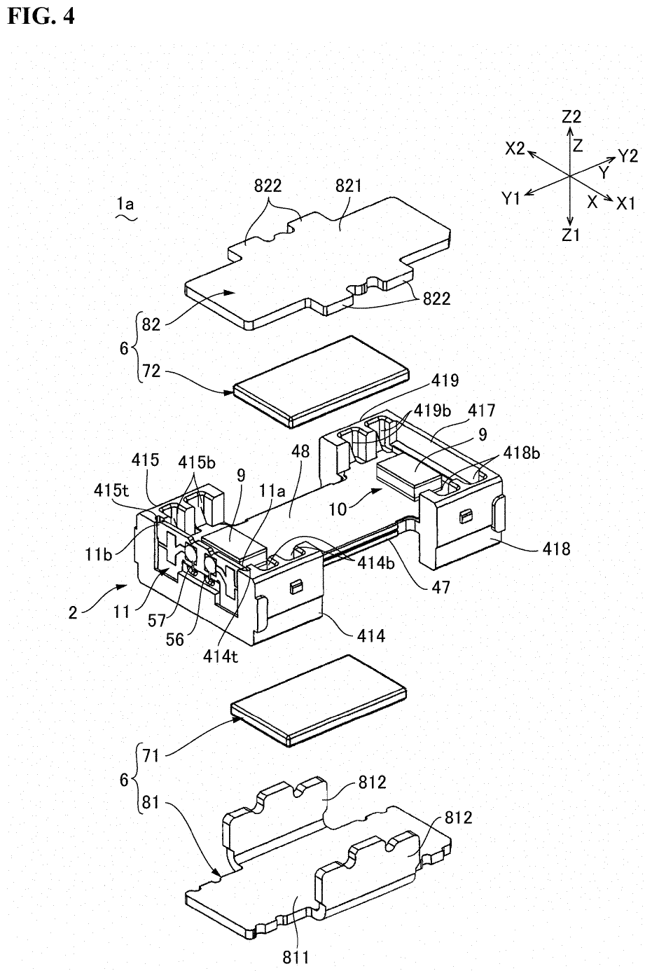

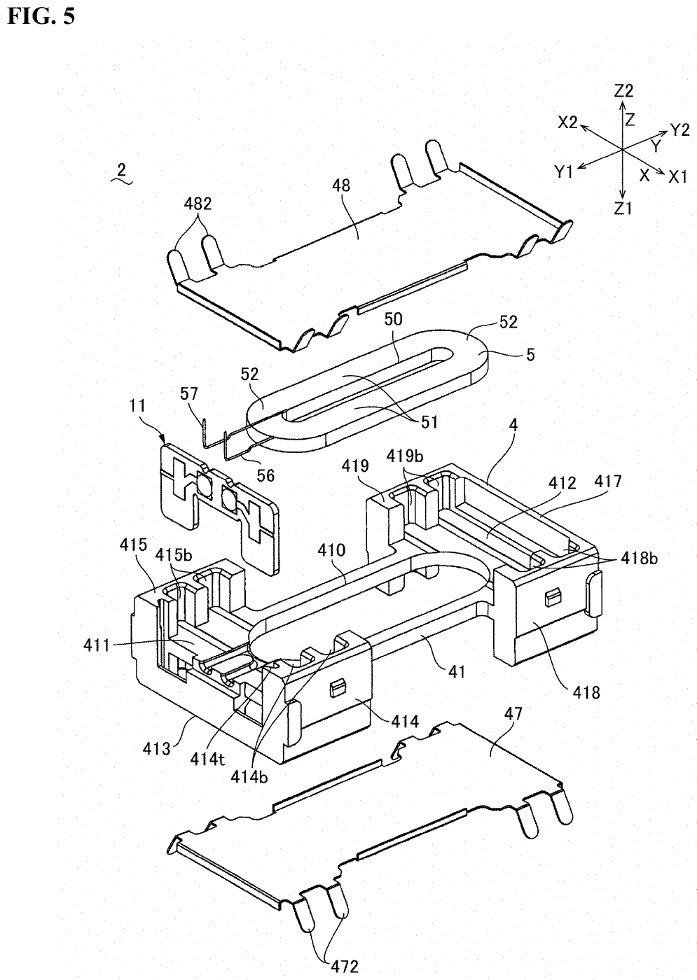

FIG. 1 is a perspective view illustrating one aspect of an actuator 1 according to a first embodiment of the present invention. FIG. 2 is a YZ sectional view of the actuator 1 in FIG. 1. FIG. 3 is an exploded perspective view of the actuator 1 in FIG. 1. FIG. 4 is an exploded perspective view of the actuator 1 in FIG. 1 disassembled into a fixed body 2 and a movable body 6. FIG. 5 is an exploded perspective view of the fixed body 2 in FIG. 4 as viewed from the other side Z2 in the first direction Z.

The actuator 1 in FIG. 1 functions as a tactile device for notifying the user of the actuator 1 of information based on the vibration in the second direction X. Therefore, the actuator 1 can be used as an operating member of a game machine or the like, and can realize a new feeling by vibration or the like.

As illustrated in FIG. 2, FIG. 3 FIG. 4, and FIG. 5, the actuator 1 includes the fixed body 2 including a case 3 having a rectangular shape defining an outer shape of the actuator 1, and the movable body 6 supported movably in the second direction X with respect to the fixed body 2 within the case 3. The movable body 6 vibrates in the second direction X to output the information.

The fixed body 2 has the case 3, a coil holder 4, a coil 5 and a power supply board 11. The movable body 6 includes permanent magnets (a first permanent magnet 71 and a second permanent magnet 72) and yokes (a first yoke 81 and a second yoke 82). The coil 5 and the permanent magnets (the first permanent magnet 71 and the second permanent magnet 72) constitute a magnetic drive mechanism 1a for moving the movable body 6 relative to the fixed body 2. The movable body 6 is supported by the fixed body 2 via a damper member 9, which is provided between the movable body 6 and the fixed body 2. The damper member 9 constitutes a damper mechanism 10 between the movable body 6 and the fixed body 2.

### Structure of Movable Body 6

As illustrated in FIG. 2, FIG. 3 and FIG. 4, the movable body 6 includes the first yoke 81 arranged on one side Z1 in the first direction Z with respect to the coil 5, and the first permanent magnet 71 having a flat plate shape held on the other side Z2 in the first direction Z of the first yoke 81 so as to face the coil 5 on the one side Z1 in the first direction Z. The movable body 6 includes the second yoke 82 disposed on the other side Z2 in the first direction Z with respect to the coil 5, and the second permanent magnet 72 having a flat plate shape held on the surface of the one side Z1 in the first direction Z of the second yoke 82 so as to face the coil 5 on the other side Z2 in the first direction Z. In the present embodiment, the movable body 6 includes the first yoke 81, the first permanent magnet 71, the second yoke 82, and the second permanent magnet 72.

The first yoke 81 includes a flat plate portion 811 to which the first permanent magnet 71 is fixed, and a pair of connecting portions 812 bent from the end portions on both sides of the flat plate portion 811 in the second direction X to the other side Z2 in the first direction Z. The second yoke 82 has a flat plate portion 821 to which the second permanent magnet 72 is fixed. The flat plate portion 821 has a pair of projecting portions 822 projecting to the one side X1 and the other side X2 in the second direction X in the middle portion in the third direction Y. The pair of connecting portions 812 of the first yoke 81 are connected to the pair of projecting portions 822 by a method such as welding. The first permanent magnet 71 and the second permanent magnet 72 are magnetized to be a different polarity with respect to the one side X1 in the first direction and the other side X2 in the first direction, respectively.

### Structure of Fixed Body 2

As illustrated in FIG. 1 and FIG. 2, in the fixed body 2, the case 3 includes a first case member 31 positioned on the one side Z1 in the first direction Z and a second case member 32 overlapping with the first case member 31 on the other side Z2 in the first direction Z. Furthermore, the case 3 is provided by connecting a pair of side plate portions 321 provided on both sides of the second case member 32 in the second direction X to a pair of side plate portions 311 provided on both sides of the first case member 31 in the second direction X respectively. At this time, the coil holder 4, the coil 5 and the movable body 6 in FIG. 2 and FIG. 5 are accommodated between the first case member 31 and the second case member 32.

As illustrated in FIG. 5, the coil 5 is an air-core coil having an annular planar shape wound in an oval shape, and is held by the coil holder 4. The coil 5 includes two long sides 51 extending in the third direction Y in parallel in the second direction X, and two short sides 52 of a circular arc shape connecting both ends of the two long sides 51 in the third direction Y. With respect to the coil 5 configured the above, the first permanent magnet 71 faces the long sides 51 on the one side Z1 of the first direction Z, and the second permanent magnet 72 faces the long sides 51 on the other side Z2 of the first direction Z. The coil holder 4 has a plate portion 41, in which a coil arrangement hole 410, which is an oval through hole in which the coil 5 is arranged inside, is opened in the first direction Z.

At an end 411 of the one side Y1 of the plate portion 41 in the third direction Y, a side plate portion 413 protrudes from the edge of the one side Y1 in the third direction Y toward the one side Z1 in the first direction Z, and side plate portions 414 and 415 protrudes from the edge of the one side X1 of X and the edge of the other side X2 in the second direction X toward the one side Z1 and the other side Z2 in the first direction Z. Among the inner surfaces of the side plate portions 414 and 415, provided are recessed portions 414b and 415b each having a groove shape extending in the first direction Z toward the other side Z2 in the first direction Z with respect to the plate portion 41. A or plural similar groove-shaped recesses (not illustrated) are formed on the one side Z1 in the first direction Z relative to the plate portion 41 among the inner surfaces of the side plate portions 414 and 415.

At the end 412 of the other side Y2 of the plate portion 41 in the third direction Y, side plate portions 417, 418 and 419 project from the edge of the other side Y2 in the third direction Y, the edge of the one side X1 in the second direction X, and the edge of the other side X2 in the second direction X toward the one side Z1 and the other side Z2 in the first direction Z. Among the inner surfaces of the side plate portions 418 and 419, recessed portions 418b and 419b each having a groove shape extend in the first direction Z toward the other side Z2 in the first direction Z with respect to the plate portion 41. A or plural similar groove-shaped recesses (not illustrated) are also formed on the one side Z1 in the first direction Z relative to the plate portion 41 among the inner surfaces of the side plate portions 418 and 419.

Slits 414t and 415t are formed in the side plate portions 414 and 415. The ends 11a and 11b on both sides of the power supply board 11 are held by the slits 414t and 415t. The ends 56 and 57 of the coil wire constituting the coil 5 are connected to the power supply board 11 by solder or the like.

### Configuration of First Plate 47 and Second Plate 48

As illustrated in FIG. 2, FIG. 4 and FIG. 5, the fixed body 2 includes a first plate 47 which overlaps the coil arrangement hole 410 and the plate portion 41 from the one side Z1 in the first direction Z. The coil 5 is fixed to the first plate 47 and the plate portion 41 by an adhesive 20 filled in at least an air-core portion 50 of the coil 5. Accordingly, the coil 5 is opposed to the first permanent magnet 71 via the first plate 47 in the first direction Z. The first plate 47 is fixed to the plate portion 41 by the adhesive 20.

The fixed body 2 has a second plate 48 which overlaps the coil arrangement hole 410 and the plate portion 41 from the other side Z2 in the first direction Z. The coil 5 is fixed to the second plate 48 by the adhesive 20 filled in at least the air-core portion 50 of the coil 5. Accordingly, the coil 5 is opposed to the second permanent magnet 72 via the second plate 48 in the first direction Z. The second plate 48 is fixed to the plate portion 41 by the adhesive 20.

The first plate 47 and the second plate 48 are non-magnetic materials. According to the present embodiment, the first plate 47 and the second plate 48 are metallic plates. More specifically, the first plate 47 and the second plate 48 are non-magnetic stainless steel plates.

The first plate 47 has a convex portion 472 having a claw shape obliquely projecting from both sides in the second direction X toward the one side Z1 in the first direction Z. The convex portion 472 is resiliently in contact with the inside of a groove-like concave portion (not illustrated) formed in the side plate portions 414, 415, 418 and 419, and is held by the coil holder 4. The second plate 48 has a convex portion 482 having a claw shape obliquely projecting from both sides in the second direction X toward the other side Z2 in the first direction Z. The convex portion 482 is resiliently in contact with the inside of groove-like concave portions 414b, 415b, 418b and 419b formed in the side plate portions 414, 415, 418 and 419, and is held by the coil holder 4.

Thus, in the actuator 1 of the present embodiment, placed is the coil 5 on the inner side of the coil arrangement hole 410 penetrating the plate portion 41 of the coil holder 4 in the first direction Z. Further, the first plate 47 is disposed so as to overlap the coil arrangement hole 410 and the plate portion 41 from the one side Z1 in the first direction Z. Thus, when the adhesive 20 is filled in the air-core portion 50 of the coil 5, the adhesive 20 flows between the coil 5 and the coil holder 4, between the coil 5 and the first plate 47, and between the first plate 47 and the coil holder 4. Therefore, when the adhesive 20 is cured, the coil 5, the first plate 47 and the coil holder 4 are fixed by the adhesive 20. Thus, unlike the case where an adhesive is poured into the gap between the outer peripheral surface of the coil 5 and the inner peripheral surface of the coil arrangement hole 410, the coil 5 arranged in the coil arrangement hole 410 of the coil holder 4 can be properly bonded to the coil holder 4. Further, the first plate 47 is interposed between the first permanent magnet 71 and the coil 5. Therefore, even when the movable body 6 moves to the one side Z1 in the first direction Z, the first permanent magnet 71 and the coil 5 do not directly contact with each other. Therefore, the coil 5 is hardly damaged. In addition, the second plate 48 is interposed between the second permanent magnet 72 and the coil 5. Therefore, even when the movable body 6 is moved to the other side Z2 in the first direction Z, the second permanent magnet 72 and the coil 5 are not directly direct contact with each other. Therefore, the coil 5 is hardly damaged. Further, the first plate 47 and the second plate 48 are metal plates. Therefore, the heat generated by the coil 5 can be efficiently dissipated through the first plate 47 and the second plate 48.

### Configuration of Damper Member 9

Referring to FIG. 2, FIG. 3, FIG. 4 and FIG. 5, the movable body 6 is supported by the damper member 9 provided between the movable body 6 and the fixed body 2 so as to be movable in the second direction X and the third direction Y. Accordingly, a leaf spring or the like that supports the movable body 6 movably in the second direction X and the third direction Y is not disposed between the movable body 6 and the fixed body 2. The resonance frequency of the movable body 6 with respect to the fixed body 2 is controlled by the damper member 9.

The damper member 9 is provided at a portion where the first yoke 81 and the first plate 47 are opposed to each other in the first direction Z. The damper member 9 is provided at a portion where the second yoke 82 and the second plate 48 are opposed to each other in the first direction Z. Therefore, the movable body 6 can be movably supported in the second direction X without using a leaf spring or the like. In the present embodiment, the damper member 9 is a plate shape. More specifically, the damper member 9 is a flat plate shape.

### Detailed Configuration of Damper Member 9

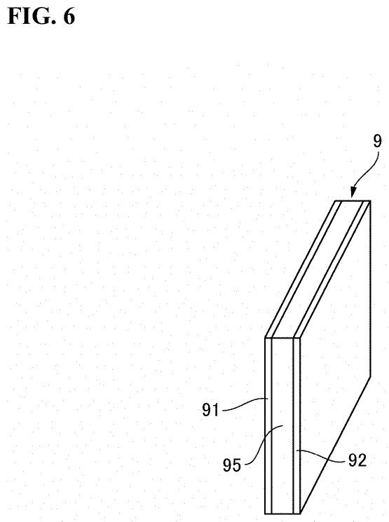

FIG. 6 is a perspective view of the damper member 9 in FIG. 2 or the like. As illustrated in FIG. 6, the damper member 9 includes a gel member 95, a first sheet member 91 joined to a surface of the gel member 95 on the side of one of the movable body 6 and the fixed body 2. Also, the damper member 9 includes a second sheet member 92 joined to a surface of the gel member 95 on the side of the other of the movable body 6 and the fixed body 2. Therefore, in the damper member 9, the first sheet member 91 is in contact with the movable body 6, and the second sheet member 92 is in contact with the fixed body 2. In the damper member 9 of the present embodiment, the first sheet member 91 is bonded to the movable body 6, and the second sheet member 92 is bonded to the fixed body 2. In the present embodiment, the damper member 9 is disposed between the movable body 6 and the fixed body 2 in a state in which the gel member 95 is compressed in the thickness direction.

The gel member 95 is a silicone gel or the like. For example, the gel member 95 is a silicone gel in which the base polymer is an organopolysiloxane. The gel member 95 is, for example, a silicone gel having a penetration degree of 90 degrees to 110 degrees. As specified in JIS-K-2207 and JIS-K-2220, the penetration degree is a value that represents a depth of penetration of a ¼ cone needle with a total load of 9.38 g in 5 seconds at 25 centigrade in 1/10 mm increments. The penetration degree means that the smaller this value is, the harder it is.

Each of the first sheet member 91 and the second sheet member 92 is a plastic sheet, a metal sheet, a laminated sheet of the metal sheet and the plastic sheet, or the like, and is thinner than the gel member 95. As the plastic sheet, a sheet such as polyethylene terephthalate, acrylic resin, polyether ether ketone can be used.

Each of the first sheet member 91 and the second sheet member 92 is flexible and is joined to the gel member 95 by binding to the gel member 95. The first sheet member 91 and the second sheet member 92 are sheets that are cut together with the gel member 95. Therefore, the first sheet member 91 and the second sheet member 92 have the same size or substantially the same size as the gel member 95.

### Operation

In the actuator 1 of the present embodiment, when power is supplied to the coil 5 from the outside (upper device) through the power supply board 11, the movable body 6 reciprocates in the second direction X by the magnetic drive mechanism 1a including the coil 5, the first permanent magnet 71 and the second permanent magnet 72. Therefore, the user who has the actuator 1 in her/his hand can obtain information by the vibration from the actuator 1. At this time, the frequency of the signal waveform applied to the coil 5 changes, for example, based on the information to be transmitted. Further, the polarity is inverted by the signal waveform applied to the coil 5. At that time, during the periods when the polarity of the drive signal is negative and positive, the speed difference is provided in accordance with the change in voltage. As a result, a difference occurs between the acceleration when the movable body 6 moves to the one side X1 in the second direction X and the acceleration when the movable body 6 moves to the other side X2 in the second direction X. Therefore, the user can obtain a feeling that the actuator 1 moves to the one side X1 or the other side X2 in the second direction X.

Also, the damper member 9 having the gel member 95 is provided between the movable body 6 and the fixed body 2. Therefore, it is possible to suppress the resonance of the movable body 6. Here, the damper member 9 is provided between the first plate 47 and the first yoke 81, and between the second plate 48 and the second yoke 82. Therefore, no case 3 is used to provide the damper member 9. By this, it is possible to provide the damper member 9 between the fixed body 2 and the movable body 6 without using the case 3. Therefore, the damper member 9 can be provided in the middle of the assembly where the case 3 is not provided. Accordingly, it is possible to measure the vibration characteristic that includes a damper property during the manufacture. Also, no case 3 is used to provide the damper member 9. Therefore, it is possible to provide the damper member in the actuator which does not have the case 3.

Also, the damper member 9 is provided at a position opposed to the fixed body 2 and the movable body 6 in the first direction Z intersecting with the second direction X (vibration direction). Therefore, when the movable body 6 vibrates in the second direction X, the gel member 95 deforms in the shearing direction, and the gel member 95 prevents resonance. Therefore, even when the movable body 6 vibrates in the second direction X, the change in the elastic modulus of the gel member 95 is small. Therefore, the resonance of the movable body 6 can be effectively suppressed. That is, the gel member 95 is a viscoelastic member and has linear or non-linear expansion and contraction characteristics depending on the expansion and contraction direction. For example, when the gel member 95 is pressed in the thickness direction (axial direction) to be compressively deformed, the gel member 95 has an expansion and contraction characteristic in which the non-linear component is larger than the linear component (spring coefficient). On the other hand, when the gel member 95 is pulled and extends in the thickness direction (axial direction), the gel member 95 has an expansion and contraction characteristic in which the linear component (spring coefficient) is larger than the non-linear component (spring coefficient). When the gel member 95 is deformed in the direction (shearing direction) intersecting with the thickness direction (axial direction), movement in any direction causes deformation in the pulling and stretching direction. Thus, in this case, the gel member 95 has a deformation characteristic having the linear component (spring coefficient) larger than the non-linear component (spring coefficient). In the present embodiment, the gel member 95 is configured to be deformed in the shear direction when the movable body 6 vibrates in the second direction X. Therefore, in the gel member 95, the spring force in the motion direction becomes constant when the movable body 6 vibrates in the second direction X. Therefore, by using the spring element in the shearing direction of the gel member 95, the reproducibility of the vibration acceleration to the input signal can be improved. Accordingly, it is possible to realize vibration with delicate nuances.

### Manufacturing Method of Damper Member 9

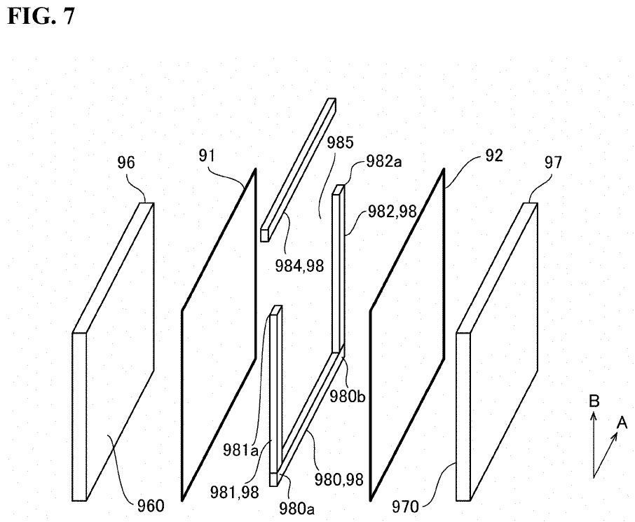

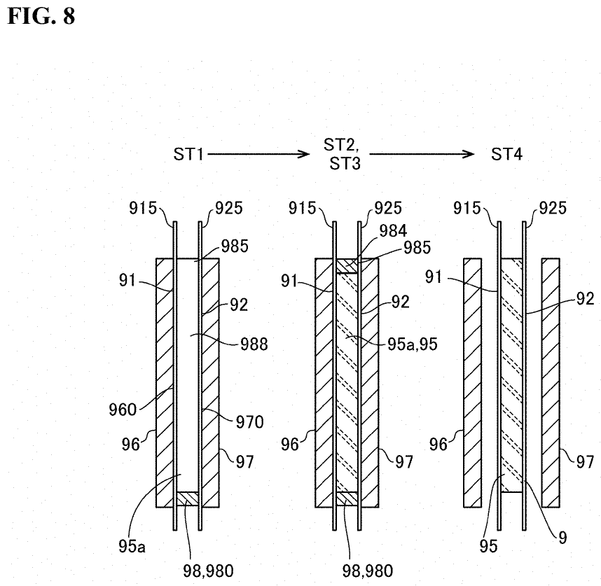

FIG. 7 is an explanatory view of a manufacturing apparatus of the damper member 9 in FIG. 6. FIG. 8 is an explanatory view illustrating a method of manufacturing the damper member 9 in FIG. 6. The damper member 9 may be manufactured in a size to be used for the damper mechanism 10. Also, the damper member 9 may be manufactured in a size larger than the size used for the damper mechanism 10 and then cut. The following describes the latter aspect, but the description is made as “damper member 9”, “first sheet member 91”, “second sheet member 92”, and “gel member 95” regardless of the size.

As illustrated in FIG. 7 and FIG. 8, the manufacturing apparatus includes a first mold member 96, a spacer 98, and a second mold member 97. The first mold member 96 and the second mold member 97 each is a glass plate or the like, and is a flat plate. The spacer 98 includes a bottom plate portion 980 located below in the filling step ST2 described later with reference to FIG. 8, a first side plate portion 981 extending in one direction B intersecting with an extending direction A from one end 980a of the bottom plate portion 980 in the extending direction A, and a second side plate portion 982 extending in the one direction B from the other end 980b of the bottom plate portion 980 in the extending direction A. A space between the end 981a opposite to the bottom plate portion 980 of the first side plate portion 981 and the end 982a opposite to the bottom plate portion 80 of the second side plate portion 982 is a filling port 985. In the present embodiment, an upper plate 984 is also used to reinforce the spacer 98.

In order to manufacture the damper member 9, in the assembly step ST1 in FIG. 8, the second mold member 97 is placed to face the first mold member 96 via an air gap 988. At that time, the first sheet member 91 is provided along the surface 960 of the first mold member 96 on the side of the air gap 988, and the second sheet member 92 is provided along the surface 970 of the second mold member 97 on the side of the air gap 988. By intervening a volatile organic solvent (not illustrated) such as isopropyl alcohol, 2-butanol, 1-propanol, etc. between the first mold member 96 and the first sheet member 91 and between the second mold member 97 and the second sheet member 92, the adhesion between the first mold member 96 and the first sheet member 91 and the adhesion between the second mold member 97 and the second sheet member 92 can be achieved thanks to the surface tension of the organic solvent.

In the present embodiment, the spacer 98 is provided between the first sheet member 91 and the second sheet member 92. Consequently, the spacer 98 is in the state of surrounding the air gap 988 with the filling port 985 remaining. This state is maintained by clamping the first mold member 96 and the second mold member 97 from both sides by a restraining member (not illustrated) or the like. At least the surface of the spacer 98 on the side of the air gap 988 is a fluorine resin such as tetrafluoroethylene resin. In the present embodiment, the entire spacer 98 is a fluorine resin. However, the surface of the spacer 98 on the air gap 988 side or the entire spacer 98 may be made of resin such as polyacetal resin, or metal material such as iron or aluminum.

In the present embodiment, end portions 915 and 925 of the first sheet member 91 and the second sheet member 92 on the side where the filling port 985 of the spacer 98 is located are protruded. Therefore, in the filling step ST2, after a liquid gel material 95a uncured is filled in the air gap 988 from the end portions 915, 925 through the filling port 985, the filling port 985 is closed by the upper plate 984. The liquid gel material 95a is, for example, a two-liquid mixing type, and has room temperature curability. As the liquid gel material 95a, for example, an addition reaction type silicone gel is used, but a condensation reaction type silicone gel can also be used.

Next, in the curing step ST3, the liquid gel material 95a is cured to become the gel member 95. As a result, the first sheet member 91 and the second sheet member 92 are joined to the gel member 95 by binding to the gel member 95. More specifically, the liquid gel material 95a includes a silicone polymer having an active group such as a silanol group, and a crosslinking agent that crosslinks the silicone polymer using the active group. The crosslinking agent crosslinks the silicone polymer to cure the liquid gel material 95a and binds the gel member 95 with the first sheet member 91 and the second sheet member 92. When the liquid gel material 95a is cured, the liquid gel material 95a may be heated. In both cases, the organic solvent is evaporated between the first mold member 96 and the first sheet member 91 and between the second mold member 97 and the second sheet member 92.

Next, in the releasing step ST4, the first mold member 96, the second mold member 97 and the spacer 98 are removed. Then, when used in the damper mechanism 10, the damper member 9 is cut into a predetermined size for each sheet member.

When the first sheet member 91 and the second sheet member 92 are plastic sheets, by applying plasma treatment, UV treatment, silicone treatment, silane coupling treatment or the like to the surface on the side where the gel member 95 contacts, the joint strength of the first sheet member 91 and the second sheet member 92 to the gel member 95 can be enhanced.

As explained above, in the present embodiment, the damper member 9 includes the gel member 95, the first sheet member 91 is joined to the surface of the gel member 95 on one side, and the second sheet member 92 is joined to the surface of the gel member 95 on the other side. Therefore, when assembling the actuator 1, the damper member 9 is less likely to be bent excessively due to its own weight or the like. Also, in the assembly process of the actuator 1, when the suction head or the like holds the damper member 9, the damper member 9 can be held from the side of the first sheet member 91 or the side of the second sheet member 92, and the suction head or the like does not contact the gel member 95. Therefore, the situation where the damper member 9 is adsorbed to the suction head or the like hardly occurs. Therefore, it is easy to handle the damper member 9 using the gel member 95.

Also, at the damper member 9, the first sheet member 91 and the second sheet member 92 are bonded to the movable body 6 and the fixed body 2 respectively. For this reason, even in the case where the gel member 95 has the property of being difficult to bond, the damper member 9 can be easily bonded.

### Second Embodiment

In the following description, a description will be given to the case where the central axis of the movable body 6 is taken as the axis line L and the movable body 6 is driven in the direction along the axis line L. Therefore, the driving direction of the movable body 6 is the direction along the axis line L. Also, in the following explanation, one side of the direction (drive direction) in which the axis line L extends is denoted by L1 and the other side is denoted by L2. The fundamental configuration of the actuator 1 of the present embodiment is the same as that of the first embodiment. Therefore, the corresponding parts are denoted by the same reference numerals and the description thereof will be omitted.

### General Configuration

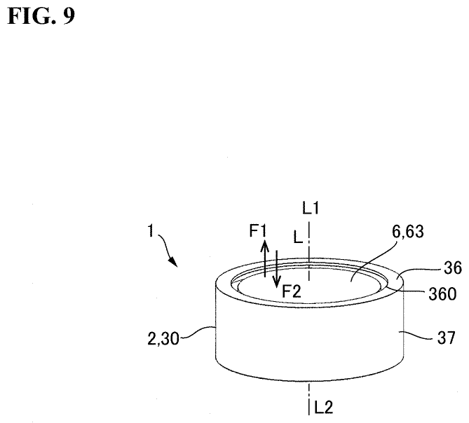

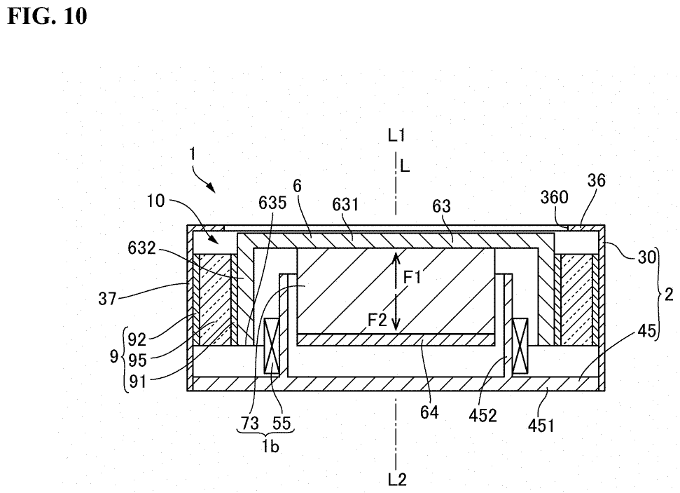

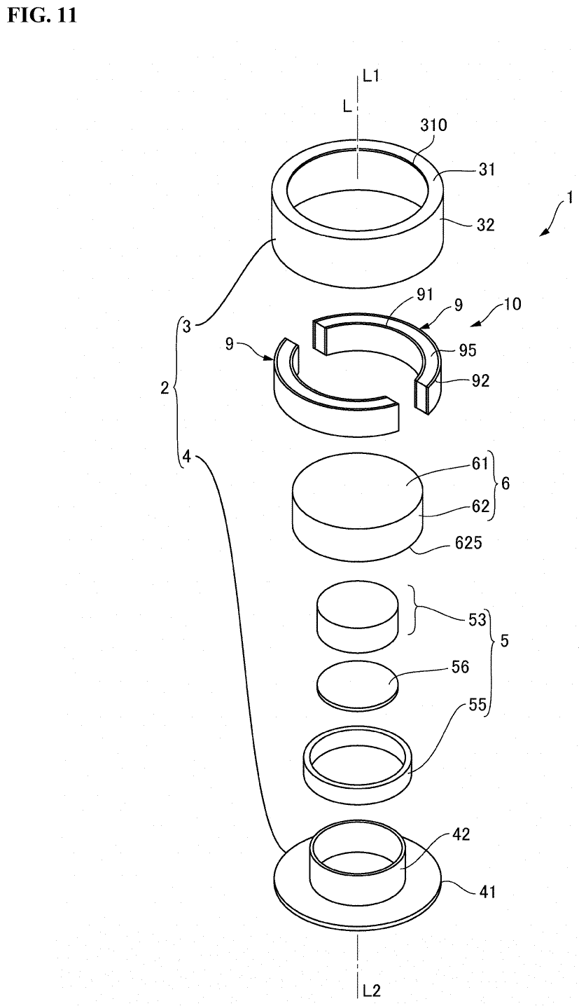

FIG. 9 is a perspective view illustrating an aspect of the actuator 1 according to a second embodiment of the present invention. FIG. 10 is an exploded perspective view schematically illustrating a cross section of the actuator 1 in FIG. 9. FIG. 11 is an exploded perspective view of the actuator 1 illustrated in FIG. 9.

As illustrated in FIG. 9, FIG. 10 and FIG. 11, the actuator 1 of the present embodiment has the fixed body 2, the movable body 6, and a magnetic drive mechanism 1b that linearly drives the movable body 6 along the axis line L with respect to the fixed body 2. The magnetic drive mechanism 1b includes a permanent magnet 73 provided on the movable body 6 and the coil 55 provided on the fixed body 2. The actuator 1 has the damper member 9 provided between the fixed body 2 and the movable body 6. The damper member 9 constitutes the damper mechanism 10 between the fixed body 2 and the movable body 6. A spring member or the like may be provided between the fixed body 2 and the movable body 6. In the present embodiment, a spring member or the like is not provided between the fixed body 2 and the movable body 6. The movable body 6 is supported by the fixed body 2 so as to be movable in the axis line L direction through only the damper member 9.

### Structure of Fixed Body 2

The fixed body 2 has a case 30 having a cylindrical shape and a holder 45 for closing an opening on the other side L2 in the direction of the axis line L of the case 30. The case 30 has an end plate portion 36 located on the one side L1 in the direction of the axis line L, and a body portion 37 extending from the outer edge of the end plate portion 36 toward the other side L2 in the direction of the axis line L. In the end plate portion 36, a portion through which the axis line L passes is an opening 360. The holder 45 has a bottom plate portion 451 fixed to the body portion 37, and a cylindrical portion 452 projecting from the center of the bottom plate portion 451 toward the one side L1 in the direction of the axis line L. The outer diameter of the cylindrical portion 452 is smaller than that of the body portion 37 of the case 30. In the present embodiment, the end plate portion 36 and the bottom plate portion 451 are circular, and the body portion 37 is cylindrical.

### Structure of Movable Body 6

The movable body 6 has a first yoke 63. The first yoke 63 includes an end plate portion 631 positioned on the one side L1 in the direction of the axis line L, and a body portion 632 extending from the outer edge of the end plate portion 631 toward the other side L2 in the direction of the axis line L. The body portion 632 is smaller than the body portion 37 of the case 30. Thus, the body portion 632 is located inside the body portion 37 of the case 30. The first yoke 63 is smaller in than the opening 360 of the case 30. Therefore, even if the movable body 6 moves in the direction of the axis line L, the movable body 6 does not interfere with the case 30. The body portion 632 is larger than the outer diameter of the cylindrical portion 452 of the holder 45. Therefore, the body portion 632 is located outside the cylindrical portion 452 of the holder 45.

### Configuration of Magnetic Drive Mechanism 1ba

In the magnetic drive mechanism 1b, the permanent magnet 73 is fixed to the surface of the other side L2 of the end plate portion 631 in the direction of the axis line L inside the body portion 632 of the first yoke 63 by a method such as bonding. The permanent magnet 73 has a cylindrical shape, and is magnetized such that the N pole and the S pole are adjacent to each other in the direction of the axis line L (driving direction). A second yoke 64 having a disk shape is joined to the surface of the permanent magnet 73 on the other side L2 in the direction of the axis line L by a method such as bonding.

The coil 55 is held to the outer circumferential surface of the cylindrical portion 452 of the holder 45 around the side of the bottom plate portion 451 (the root side). The inner side of the body portion 632 of the first yoke 63 is opposed to the outer side of the second yoke 64 via the coil 55 in the radial direction.

### Configuration of Damper Member 9

In the damper mechanism 10, the damper member 9 is disposed between the fixed body 2 and the movable body 6 in a portion opposed in the direction orthogonal to the driving direction by the magnetic drive mechanism 1b (the direction of the axis line L). In the present embodiment, the body portion 37 of the case 30 is cylindrical, the body portion 632 of the first yoke 63 is cylindrical, and the body portion 37 and the body portion 632 face each other all around the axis line L. In the present embodiment, the damper member 9 has a plate shape curved in an arc shape, and is disposed at two places in the circumferential direction.

In the damper member 9, the one surface in the thickness direction is in contact with the body portion 623 of the first yoke 63, and the other surface in the thickness direction is in contact with the body portion 37 of the case 30. In the present embodiment, the one surface of the damper member 9 in the thickness direction is bonded to the body portion 632 of the first yoke 63, and the other surface in the thickness direction is bonded to the body portion 37 of the case 30.

In the present embodiment, the damper member 9 is different in shape from the first embodiment. However, as in the first embodiment, the damper member 9 includes the gel member 95 and the first sheet member 91 joined to the surface of the gel member 95 on the side of one of the movable body 6 and the fixed body 2. Also, the damper member 9 includes a second sheet member 92 joined to the surface of the gel member 95 on the side of the other of the movable body 6 and the fixed body 2. More specifically, the damper member 9 includes the gel member 95, the first sheet member 91 joined to the surface of the gel member 95 on the side of the body portion 632 of the first yoke 63, and a second sheet member 92 joined to the surface of the gel member 95 on the side of the body portion 37 of the case 30. Therefore, in the damper member 9, the first sheet member 91 is in contact with the body portion 632 of the first yoke 63, and the second sheet member 92 is in contact with the body portion 37 of the case 30. In the present embodiment, in the damper member 9, the first sheet member 91 is bonded to the body portion 632 of the first yoke 63, and the second sheet member 92 is bonded to the body portion 37 of the case 30. In the present embodiment, the first sheet member 91 and the second sheet member 92 are sheets cut together with the gel member 95.

The damper member 9 configured as described above is manufactured by providing the damper member 9 by the method described with reference to FIG. 7 and FIG. 8, then cutting the first sheet member 91, the gel member 95 and the second sheet member 92, and then curving. Therefore, the first sheet member 91 and the second sheet member 92 have the same or substantially the same size as the gel member 95.

Further, in the case of manufacturing the damper member 9 by the method described with reference to FIG. 7 and FIG. 8, the damper member 9 of the present embodiment may use the first mold member 96 and the second mold member 97 curved in an arc shape, and may provide the gel member 95 between the first sheet member 91 and the second sheet member 92, which are disposed between the first mold member 96 and the second mold member 97. In this case, the first sheet member 91 has a circumferential length shorter than that of the second sheet member 92.

### Function and Effect of the Present Embodiment

In the actuator 1 of the present embodiment, when the energization of the coil 55 is controlled, the movable body 6 vibrates along the direction of the axis line L as indicated by the arrows F1 and F2. At that time, in the damper member 9, the gel member 95 is sheared and deformed. Further, in the present embodiment, as in the first embodiment, when assembling the actuator 1, the damper member 9 is less likely to be bent excessively due to its own weight and the like. Further, when the suction head or the like holds the damper member 9, the damper member 9 can be held from the side of the first sheet member 91 or the side of the second sheet member 92, and the suction head or the like does not contact the gel member 95. Therefore, the situation where the damper member 9 is adsorbed to the suction head or the like hardly occurs. In the damper member 9, the first sheet member 91 and the second sheet member 92 are bonded to the movable body 6 and the fixed body 2, respectively. Therefore, even in the case where the gel member 95 has a property of being difficult to bond, the present embodiment has the same effect as that of the first embodiment such that the damper member 9 can be easily bonded.

### Third Embodiment

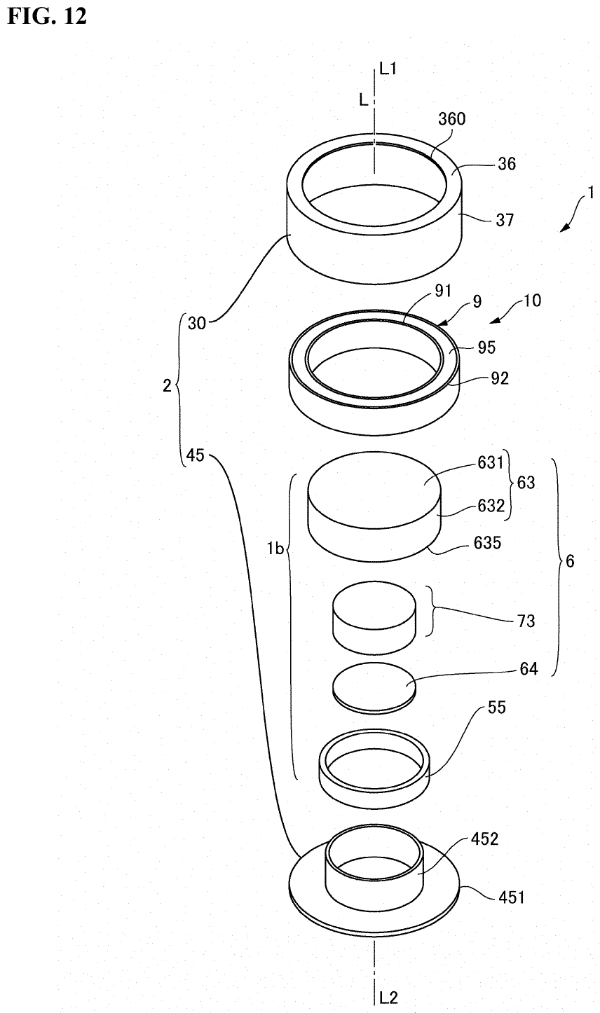

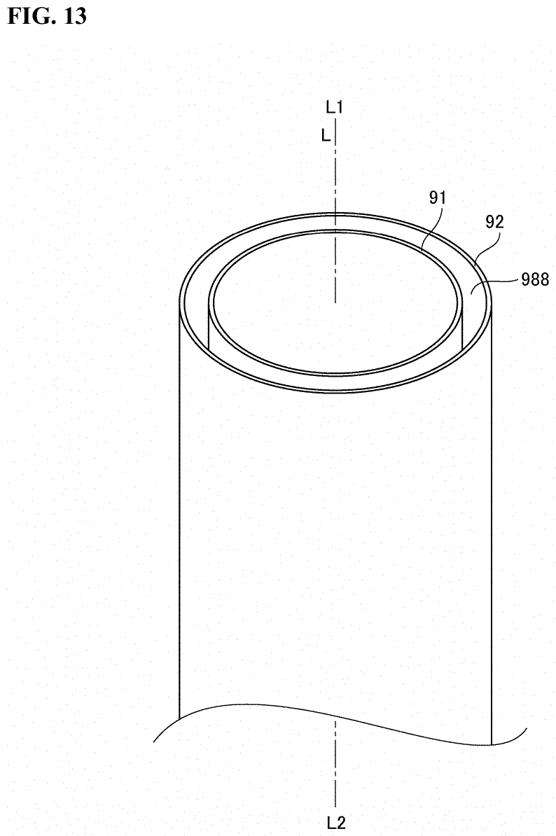

FIG. 12 is an exploded perspective view of the actuator 1 according to a third embodiment of the present invention. FIG. 13 is an explanatory view illustrating a method of manufacturing the damper member 9 in FIG. 12. Since the basic configuration of the actuator 1 of the present embodiment is the same as that of the second embodiment, the corresponding parts are denoted by the same reference numerals and the description thereof will be omitted. Further, in the present embodiment, the appearance of the actuator 1 is the same as FIG. 9 referred to in the description of the second embodiment, and the cross section of the actuator 1 is similar to the cross section illustrated in FIG. 10 referred to in the description of the second embodiment. For this reason, the actuator 1 will be described with reference to FIG. 9, FIG. 10 and FIG. 12.

As illustrated in FIG. 9 and FIG. 10, the actuator 1 of the present embodiment includes the fixed body 2, the movable body 6, and the magnetic drive mechanism 1b for linearly driving the movable body 6 along the axis line L with respect to the fixed body 12, as in the second embodiment. The magnetic drive mechanism 1b includes the permanent magnet 73 provided on the movable body 6 and the coil 55 provided on the fixed body 2. The actuator 1 has the damper member 9 provided between the fixed body 2 and the movable body 6. The damper member 9 constitutes the damper mechanism 10 between the fixed body 2 and the movable body 6.

In the present embodiment, the damper member 9 is disposed between the body portion 37 of the case 30 and the body portion 632 of the first yoke 63 of the movable body 6, and has a cylindrical shape. More specifically, the damper member 9 has the gel member 95 having a cylindrical shape, the first sheet member 91 having a cylindrical shape and joined to a surface of the inner side of the gel member 95 in the radial direction (the side of the body portion 632 of the first yoke 63), and the second sheet member 92 having a cylindrical shape and joined to a surface of the outside of the gel member 95 in the radial direction (the side of the body portion 37 of the case 30). Therefore, the body portion 632 of the movable body 6 is positioned inside the first sheet member 91, and the body portion 37 of the case 30 is positioned outside the second sheet member 92. In this state, in the damper member 9, the first sheet member 91 is in contact with the body portion 632 of the movable body 6, and the second sheet member 92 is in contact with the body portion 37 of the case 30. In the present embodiment, in the damper member 9, the first sheet member 91 is bonded to the body portion 632 of the movable body 6, and the second sheet member 92 is bonded to the body portion 37 of the case 30.

In manufacturing the gel member 95 having the cylindrical shape, as illustrated in FIG. 13, the second sheet member 92 having a cylindrical shape is disposed outside the first sheet member 91 having a cylindrical shape as illustrated in FIG. 13. Also, for example, a spacer (not illustrated) is disposed between the first sheet member 91 and the second sheet member 92 to define the positions of the first sheet member 91 and the second sheet member 92. Next, the air gap 988 between the first sheet member 91 and the second sheet member 92 is filled with an uncured liquid gel material, and then, the liquid gel material is cured to obtain the gel member 95 illustrated in FIG. 12. As a result. the first sheet member 91 and the second sheet member 92 are joined to the gel member 95 by binding to the gel member 95.

After the spacer (not illustrated) is removed, the gel member 95 is cut in a direction orthogonal to the axis line L together with the first sheet member 91 and the second sheet member 92 to produce the damper member 9 illustrated in FIG. 12.

In such a configuration as described above, the damper member 9 has the gel member 95 in the same manner as in the first and second embodiments. Further, the first sheet member 91 is joined to the surface of the gel member 95 on one side, and the second sheet member 92 is joined to the surface of the gel member 95 on the other side. Therefore, when assembling the actuator 1, the damper member 9 is less likely to be bent excessively due to its own weight or the like. Further, when the suction head or the like holds the damper member 9, the damper member 9 can be held from the side of the first sheet member 91 or the side of the second sheet member 92, the suction head or the like does not contact the gel member 95. Therefore, the situation where the damper member 9 is adsorbed to the suction head or the like hardly occurs. Accordingly, it is easy to handle the damper member 9 using the gel member 95.

The damper member 9 having the cylindrical shape described with reference to FIG. 12 and FIG. 13 may be cut to manufacture the damper member 9 illustrated in FIG. 11.

### Other Embodiments

In the damper mechanism 10 and the actuator 1 according to the first, second and third embodiments described above, in the damper member 9, the first sheet member 91 is bonded to the movable body 6 and the second sheet member 92 is bonded to the fixed body 2. However, only one of the first sheet member 91 and the second sheet member 92 may be bonded to the movable body 6 or the fixed body 2 and the other may be in contact with the movable body 6 or the fixed body 2 without being bonded.

In the damper mechanism 10 and the actuator 1 according to the first, second and third embodiments, in the damper member 9, the sheet members are provided on both surfaces of the gel member 95. However, the sheet member may be joined to only one of both surfaces of the gel member 95. In this case, for example, it is possible to adopt an aspect in which, on one side of the gel member 95, the sheet member is bonded to the movable body 6 or the fixed body 2, and at the other side of the gel member 95, the gel member 95 is in contact with the movable body 6 or the fixed body 2 by the adsorptivity of the gel member 95 itself.

In the damper mechanism 10 and the actuator 1 according to the first, second, and third embodiments, the damper member 9 is bonded to the movable body 6 and the fixed body 2. But, for example, the gel member 95 may disposed between the movable body 6 and the fixed body 2 in a compressed state in the thickness direction, and the damper member 9 may be in contact with the movable body 6 and the fixed body 2 by the reaction force. Alternatively, the damper member 9 may be bonded to the movable body 6 and the fixed body 2 in a state where the gel member 95 is compressed in the thickness direction.

In the second and third embodiments, the damper member 9 is cylindrical. However, in a case where the body portions 632, 67 each has a square tube shape, the damper member 9 may have a square tube shape.

In the actuator 1 according to the above embodiments, the coil is held by the fixed body 2, and the permanent magnet is held by the movable body 6. However, at least an embodiment of the present invention can be applied to a case where the permanent magnet is held by the fixed body 2 and the coil is held by the movable body 6.

In the above embodiment, at least an embodiment of the present invention is applied to the actuator 1 which vibrates the movable body 6 in one direction. However, at least an embodiment of the present invention can be applied to an actuator for vibrating the movable body 6 in two directions crossing each other.

In the above embodiment, the damper member 9 is provided in the actuator 1. However, in an apparatus other than the actuator 1, at least an embodiment of the present invention may be applied to the damper member 9 disposed between the movable body and the fixed body. Further, in the above embodiments, the damper member 9 is provided so as to be in contact with both of the movable body 6 and the fixed body 2. However, at least an embodiment of the present invention can be applied to the damper member 9 provided so as to be in contact with only the movable body 6. In this case, in the damper member 9, the sheet member is joined to the surface of the gel member 95 on the movable body side, and the damper member 9 is disposed such that the sheet member is in contact with the movable body. Also, the sheet member may be bonded to the movable body.

In the above embodiment, a silicone gel is used for the gel member 95, but at least an embodiment of the present invention can be applied to a case where a gel other than silicone gel is used for the gel member 95.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A damper mechanism comprising:
a fixed body;
a movable body; and
a damper member disposed between the fixed body and the movable body so as to be in contact with both of the movable body and the fixed body, wherein
the damper member comprises a gel member, and a first sheet member joined to a surface of the gel member on a side of one of the movable body and the fixed body.

2. The damper mechanism according to claim 1, wherein
the first sheet member is bonded to the side of one of the movable body and the fixed body.

3. The damper mechanism according to claim 1, wherein
the damper member further comprises a second sheet member joined to a surface of the gel member on a side of an other of the movable body and the fixed body.

4. The damper mechanism according to claim 3, wherein
the second sheet member is bonded to the side of the other of the movable body and the fixed body.

5. The damper mechanism according to claim 1, wherein
the gel member is in a state of being compressed between the movable body and the fixed body.

6. The damper mechanism according to claim 1, wherein
the gel member comprises a silicone gel.

7. The damper mechanism according to claim 1, wherein
the damper member has a plate shape.

8. The damper mechanism according to claim 1, wherein
the damper member has a cylindrical shape.

9. An actuator comprising:
the damper mechanism according to claim 1, and
a magnetic drive mechanism configured to move the movable body relative to the fixed body.

10. A damper mechanism comprising a damper member disposed so as to be in contact with a movable body, wherein
the damper member comprises a gel member, and a sheet member joined to a surface of the gel member on a side of the movable body.

11. The damper mechanism according to claim 10, wherein
the sheet member is bonded to the movable body.

12. The damper mechanism according to claim 2, wherein
the damper member further comprises a second sheet member joined to a surface of the gel member on a side of an other of the movable body and the fixed body.

13. The damper mechanism according to claim 12, wherein
the second sheet member is bonded to the side of the other of the movable body and the fixed body.

14. The damper mechanism according to claim 13, wherein
the gel member is in a state of being compressed between the movable body and the fixed body.

15. The damper mechanism according to claim 14, wherein
the gel member comprises a silicone gel.

16. The damper mechanism according to claim 15, wherein
the damper member has a plate shape.

17. The damper mechanism according to claim 15, wherein
the damper member has a cylindrical shape.

18. An actuator comprising:
the damper mechanism according to claim 16, and
a magnetic drive mechanism configured to move the movable body relative to the fixed body.

19. An actuator comprising:
the damper mechanism according to claim 17, and
a magnetic drive mechanism configured to move the movable body relative to the fixed body.
